(19) United States
(12) Patent Application Publication
(10) Pub. No.: US 2021/0334799 A1
(43) Pub. Date: Oct. 28, 2021

(54) SYSTEMS AND METHODS FOR AUTHORIZING THIRD-PARTY TRANSACTIONS

(71) Applicant: Wells Fargo Bank, N.A., San Francisco, CA (US)

(72) Inventors: Michael Knorr, Fairfield, CT (US); Aravind Krishnasamy, San Ramon, CA (US); Jeffrey W. Levy, Newton, PA (US); Maria Marmolejos Mejia, Santo Domingo (DO); Wesley Sturgis, San Francisco, CA (US)

(21) Appl. No.: 16/105,609

(22) Filed: Aug. 20, 2018

(51) Int. Cl. G06Q 20/40; G06Q 20/02

(52) U.S. Cl. CPC G06Q 20/401; G06F 3/04847; G06Q 20/02

(57) ABSTRACT

A method of implementing a transaction including receiving, by a transaction computing system from an authorizing computing system, authorization information, generating, by the transaction computing system, an authorization profile based on the authorization information, the authorization profile associated with an authorization profile identifier, and transmitting, by the transaction computing system, the authorization profile identifier. The method further includes receiving, by the transaction computing system from a provider computing system, a request for a transaction, the request including transaction information and the authorization profile identifier, identifying, by the transaction computing system, the authorization profile based on the received authorization profile identifier, determining, by the transaction computing system, that the transaction is authorized based on the authorization profile and the transaction information, implementing, by the transaction computing system, the transaction, and transmitting, by the transaction computing system, confirmation of the transaction.

### TECHNICAL FIELD

Embodiments of the present disclosure relate generally to the field of authorizing transactions.

### BACKGROUND

A party may wish to provide for the purchase of goods or services for another party. For example, an employer may wish to provide goods or services for their employees. For example, on a business trip the employees may incur expenses for authorized goods or services and the employers may reimburse the employees for the expenses. However, the authorization process and the reimbursement process can be cumbersome (e.g., may require the employers and the employees filling out or reviewing paperwork), and may front-load the cost of the goods or services on the employees, and may require the employees to have cash or other payment means on hand to collect the goods or services, which can be undesirable (e.g., because the employees do not wish to incur the front-loaded costs, or because they are travelling in a foreign country and do not have payment means readily available). Furthermore, it may be unclear to the employees which goods or services are authorized for purchase. Other parties may also encounter similar problems when providing for the purchase of goods or services for another party (e.g., a parent providing for their child, or a person who wishes to give a gift to another party). An authorization system directed to solving these problems may be desirable.

### SUMMARY

One example embodiment relates to a method of implementing a transaction. The method includes receiving, by a transaction computing system from an authorizing computing system, authorization information, generating, by the transaction computing system, an authorization profile based on the authorization information, the authorization profile associated with an authorization profile identifier, and transmitting, by the transaction computing system, the authorization profile identifier. The method further includes receiving, by the transaction computing system from a provider computing system, a request for a transaction, the request including transaction information and the authorization profile identifier, identifying, by the transaction computing system, the authorization profile based on the received authorization profile identifier, determining, by the transaction computing system, that the transaction is authorized based on the authorization profile and the transaction information, implementing, by the transaction computing system, the transaction, and transmitting, by the transaction computing system, confirmation of the transaction.

Another example embodiment relates to another method of implementing a transaction. The method includes receiving, by a transaction computing system from an authorizing computing system, authorization parameters, generating, by the transaction computing system, authorization information based on the authorization parameters, and transmitting, by the transaction computing system to a provider computing system, the authorization information. The method further includes receiving, by the transaction computing system from the provider computing system, an indication that authorized goods or services have been collected by an authorized party, and implementing, by the transaction computing system, the transaction responsive to receiving the indication that the authorized goods or services have been collected by the authorized party.

Yet another example embodiment relates to a system. The system includes a computer memory, and a processing circuit configured to receive, from an authorizing computing system, authorization information, the authorization information including an authorizing account identifier, identify a transaction account associated with the authorizing account identifier, and generate an authorization profile based on the authorization information, the authorization profile associated with an authorization profile identifier and including an identifier of the transaction account. The processing circuit is further configured to receive, from a provider computing system, a request for a transaction, the request including transaction information and the authorization profile identifier, determine, by the transaction computing system, that the transaction is authorized based on the authorization profile and the transaction information, and implement the transaction using the transaction account associate with the authorization profile.

A further example embodiment relates to a method of implementing a transaction. The method includes receiving, by the authorizing computing system from a client device, a request for authorization for a transaction, selecting, by an authorizing computing system, authorization parameters for an authorization profile, and transmitting, by the authorizing computing system to a transaction computing system, the authorization parameters and identification information for an authorized party. The method further includes receiving, by the authorizing computing system from the transaction computing system, an indication that one or more merchants, one or more goods, or one or more services have been authorized for the authorized party, and receiving, by the authorizing computing system from the transaction computing system, an indication that the transaction has been implemented.

Various objects, aspects, features, and advantages of the disclosure will be readily understood by referring to the detailed description taken in conjunction with the accompanying drawings, in which like reference characters identify corresponding elements throughout. In the drawings, like reference numbers generally indicate identical, functionally similar, and/or structurally similar elements.

### BRIEF DESCRIPTION OF THE DRAWINGS

FIG. 1 is a schematic diagram of an authorization system, according to an example embodiment.

FIG. 2 is a flow diagram of a method of authorizing a transaction, according to an example embodiment.

FIG. 3 is a flow diagram of a method of authorizing a transaction, according to an example embodiment.

FIG. 4 is a flow diagram of a method of authorizing a transaction, according to an example embodiment.

FIG. 5 is a flow diagram of a method of authorizing a transaction, according to an example embodiment.

FIG. 6 shows a user interface for setting authorizations of providers, goods, or services, according to an example embodiment.

FIG. 7 is a user interface for viewing authorized providers, goods, or services, according to an example embodiment.

FIG. 8 is a user interface displaying verification information, according to an example embodiment.

### DETAILED DESCRIPTION

Various systems, methods, and apparatuses for facilitating transactions are described herein. For example, the systems, methods, and apparatuses can provide for an authorizing party (e.g., an employer, a parent, a gift giver, or another party) authorizing transactions (e.g., purchases). In some embodiments, the systems, methods, and apparatuses can provide for the authorizing party authorizing particular goods or services, categories of goods or services, goods or services for sale in a particular geographic area, and/or goods or services that can be purchased within a certain budget. The authorizing party may readily authorize the goods or services via a convenient graphical user interface (“GUI”) specifically designed to authorize the goods or services in a convenient manner by displaying specific information in a specific way. The authorized party, which may be referred to herein as a client, may collect or receive the authorized goods or services from a provider (e.g., a merchant) without needing to directly pay for the goods or services. In some embodiments, the client may collect the authorized goods or services by presenting an identifying token to the provider. The provider may confirm the identity of the client, and may provide the authorized goods or services. A transaction party (e.g., a financial institution, such as a bank) may process a payment or other transaction involving the goods or services, such as by debiting an account of the authorizing party and implementing a payment to the provider. In some embodiments, the provider may receive verification information (e.g. for identifying an authorized party) and associated authorization information (e.g. an indication of authorized goods or services), and may perform provider-side verification and authorization of a party attempting to collect goods or services. This provider-side verification can be especially useful when a network connection with the transaction party is down, or for providers who have intermittent network access. The provider may then notify the transaction party that the goods or services were collected, and the transaction party can implement a corresponding financial transaction (e.g. debiting an account), and may notify the authorizing party. Thus, a provider may be able to provide pre-authorized goods or services to a specific authorized party, and the specific party can readily collect the pre-authorized goods or services (e.g. simply by presenting a photo identification).

Thus the systems, methods, and apparatuses described herein solve the above mentioned problems of a cumbersome authorization process and reimbursement process by having the authorizing party select authorized goods or services via a specialized GUI, and by having a transaction party perform the transaction involving the goods or services so that the client does not have to have cash or other payment means on hand, and does not need to incur a front loaded cost and be later reimbursed, as would conventionally be the case. The client may simply present an identifying token and collect the authorized goods or services. The systems, methods, and apparatuses described herein also solve the problem of it being unclear which goods or services are authorized and what the budget is, such as by transmitting a list or other indication of the authorized goods, services, and budget to the client, or by providing such an indication via a specialized client GUI. The systems, methods, and apparatuses described herein also solve the problem of a client device 106, which may have limited computer memory or processing power, needing to store and execute transaction circuitry or transaction applications, by providing for the transaction system 102 handling one or more transaction functionalities (e.g., via the specific systems and methods described herein).

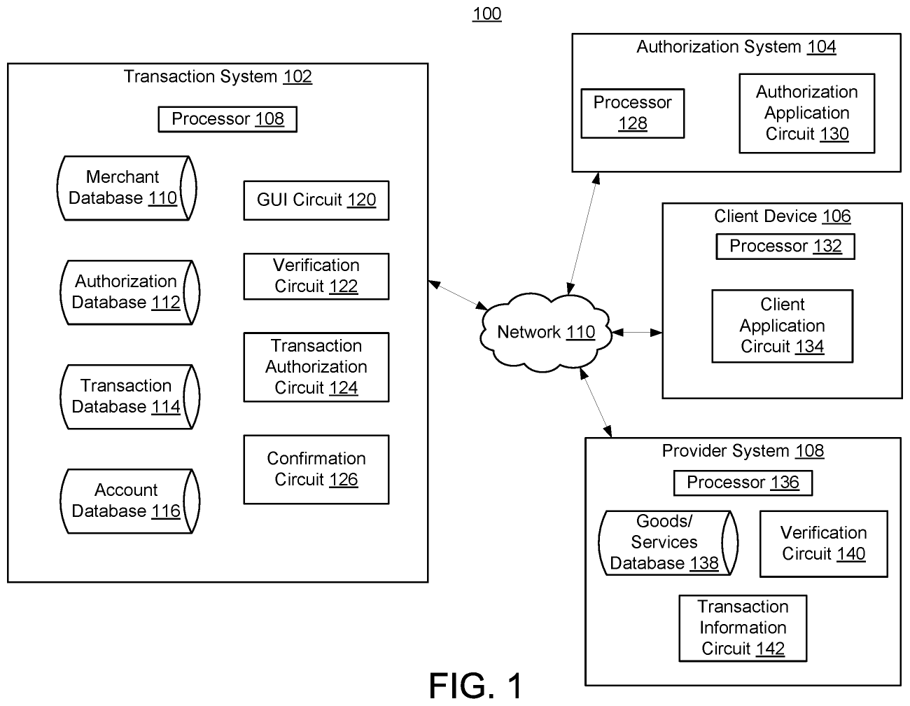

Referring now to FIG. 1, an illustration of an authentication system 100 is shown according to an example embodiment. The authentication system 100 can be implemented to facilitate improved authentication of transactions by an authenticating party on behalf of a client, or such that the client can receive an authorized good or service from a provider (e.g., a merchant). The authentication system 100 includes a transaction system 102, an authorization system 104, a client device 106, a provider system 108, and a network 110. In some embodiments, an authorizer uses the authorization system 104 to authorize purchase of a good or service for a client. The authorizer may authorize merchants, goods, and/or services (specifically, or by category or by parameter value) from a set of merchants, goods, and/or services provided or identified by the transaction system 102. The client device 106 of the client and/or the provider system 108 of a provider may receive an indication of the authorized merchants, goods, and/or services. In some embodiments, the provider uses the provider system 108 to identify the client (e.g., using an identifying token, such as a token stored on the client device, displayed on the client device, or transmitted by the client device, or a photo identification, or biometrics), confirms that the good or service is authorized, and provides the good or service to the client. In some embodiments, the transaction system 102 implements a transaction (e.g., a financial transaction, such as debiting an account belonging to the authorizer) to account for provision of the good or service. Thus, the authorizer may select and pay for a good or service, and the client may receive the good or service using the identifying token.

The transaction system 102 may include a computing system of a financial institution (e.g., a bank). The transaction system 102 may include a processor 108. The processor 108 may include one or more microprocessors, application-specific integrated circuits (ASIC), a field-programmable gate arrays (FPGA), etc., or combinations thereof. The transaction system 102 may include a computer memory. For example, the memory may include, but is not limited to, electronic, magnetic, or any other storage or transmission device capable of providing a processor with program instructions. The memory may include magnetic disk, memory chip, read-only memory (ROM), random-access memory (RAM), Electrically Erasable Programmable Read-Only Memory (EEPROM), erasable programmable read only memory (EPROM), flash memory, or any other suitable memory from which processor can read instructions. The memory may include components, subsystems, data structures, modules, scripts, applications, or one or more sets of processor-executable instructions for implementing management of a transaction account (e.g., a checking account, credit account, or savings account), including processes described herein. For example, the memory may include a merchant database 110, an authorization database 112, a transaction database 114, and an account database 116. In some embodiments, the transaction system may include a GUI circuit 120, a verification circuit 122, a transaction authorization circuit 124, and a confirmation circuit 126.

The merchant database 110 may include data related to merchants, goods, or services. For example, the merchant database 110 may include a list of merchants, and may include a list of goods or services respectively provided by the merchants. In some embodiments, the list of goods or services may be compiled based on merchant information sent to the transaction system 102 by the provider system 108. In some embodiments, the merchant database 110 includes a list of goods or services that is not specifically associated with a merchant. The merchant database 110 may store data (e.g., parameter values) related to the merchants, goods, or services. For example, the merchant database 110 may store an indication of a geographic location of the merchant (e.g., a location where the merchant provides goods or services), or a geographic location where the goods or services can be collected. The indication may be, for example, a coordinate, or an indication of a geographic zone or area that includes the location where the goods or services can be collected. The geographic zone or area need not be a single continuous zone or area. In some embodiments, the merchant database 110 may store prices of the goods or services, and/or deal or coupon information associated with the goods or services. The merchant database 110 may store data indicating a category of the merchants, goods, or services. For example, the merchant database 110 may store information indicating that one of the merchants is a hotel type merchant, or may store information indicating that one of the services is a reservation of a room of a hotel. The transaction system 102 may use the information stored in the merchant database 110 to facilitate authorization of, and implementation of, transactions.

The authorization database 112 may include one or more authorization profiles. For example, the transaction system 102 may receive authorization information and/or authorization parameters from the authorization system 104 (e.g., from an authorizing party) indicating one or more merchants, one or more goods, or one or more services that are authorized for one or more specified parties. The transaction system 102 (e.g. the GUI circuit 120, described in more detail below) may generate an authorization profile based on the received authorization information and/or authorization parameters. The authorization profile may be specific to a set of authorization parameters received from the authorization system 104 (e.g. as part of an authorization request). The authorization profile may include, or may be associated with, an authorization profile identifier that can be used to reference the authorization profile. The authorization profile can include, in addition to authorization information or authorization parameters, information regarding an authorized party or client, can include contact information for the client or for an authorizing party. The authorization profile can include verification information (e.g. a name, photograph, or biometric data for identifying an authorized party).

In some embodiments, the transaction system 102 may receive a selection of authorization parameters from the authorization system 104, and may process the authorization parameters to generate authorization information in a plain language format (e.g., including an indication of authorized merchants, goods or services). The authorization information may indicate specific merchants, goods, or services that are authorized, or may indicate categories or types of merchants, goods, or services that are authorized. The authorization information may include an indication of an authorized geographic area or zone, and may include an indication that one or more (or all) merchants, goods, or services, or categories thereof, in the authorized geographic area or zone are authorized. The authorization information may include identification information for the one or more specified and authorized parties, including a name, a user account, a client device identifier, biometric data, a personal identification number (PIN), a password, a photograph, or another token (e.g., a token generated by, or capable of being generated by, the client device 106, such as a QR code or hashed code). In some embodiments, the authorization information may include a budget (e.g., a monetary limit for a total price of one or more provided goods or services). The budget may be a universal budget, or may be particular to one or more merchants, for example.

The transaction database 114 may include transaction information. The transaction system 102 may receive the transaction information from a provider system 108. For example, a merchant provider system 108 may transmit transaction information to the transaction system 102. The transaction information may include an indication of one or more goods or services that were collected, or are to be collected (e.g., by the client). The transaction information may include an indication of one or more goods or services that were provided, or that are to be provided by a merchant to the client. The transaction information may include an identification of the merchant. The transaction information may include verification information for one or more specified parties (e.g., the client), such as a PIN, a password, biometric data, a code, a token, or a combination of tokens, that verifies that the client. The transaction information may include cost information that identifies a cost of the goods or services that were provided and collected. In some embodiments, the transaction information may include an indication that a coupon or other promotional offer was used. The transaction information may indicate that the client paid at least a portion of a total cost of the provided goods or services.

The account database 116 may include information pertaining to the authorization system 104 and/or to an authorizing entity. For example, the account database 116 may include user profile information for the authorizing entity. The user profile information may include a username or password, and may be used to verify a log-in request received by the transaction system 102 from the authorization system 104. The user profile information may include contact information that can be used to send confirmation of transactions. The contact information may, for example, specify an e-mail address or a phone number (for a phone call or for a short message service (SMS) message), or may include information for pushing a notification to a device. The contact information can include contact information for one or more of the authorizing entity, the client, or the provider. The account database 116 may include account information for a transaction account (e.g., a bank account, such as a checking or savings account, or a credit account, such as a credit card or line of credit account), including a balance of such an account. In some embodiments, the transaction system 102 is a system of a financial institution, and the transaction system 102 maintains the transaction account for the authorizing party. The transaction system 102 may update the account information (e.g., by debiting or crediting the transaction account) responsive to authorizing a transaction, such as a purchase.

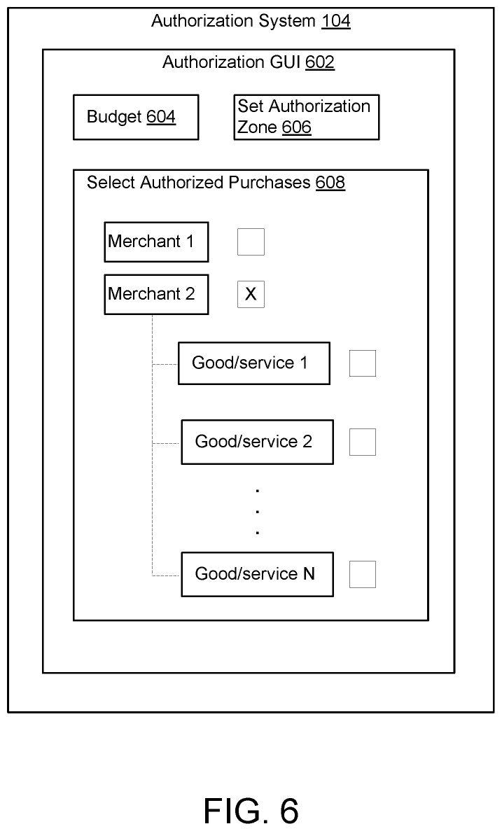

The GUI circuit 120 may include components, subsystems, data structures, modules, scripts, applications, or one or more sets of processor-executable instructions for communicating with, or for providing, an authorization GUI 602 (e.g., as shown in FIG. 6, described in more detail below). The GUI circuit 120 can provide the authorization GUI 602 to the authorization system 104, and can be used by the authorization system 104 (e.g., by an authorizing entity using the authorization system 104) to transmit authorization information to the transaction system 102. The GUI circuit 120 can access the merchant database 110 to retrieve the data related to merchants, goods, or services, and can incorporate that data into the authorization GUI 602 such that the authorization GUI 602 includes a list of merchants, goods, or services that can be authorized. The GUI circuit 120 can receive the authorization information from the GUI 602, and can store the authorization information in the authorization database 112 (e.g. as part of an authorization profile generated by the GUI circuit 120). The GUI circuit 120 may transmit at least a portion of the authorization information (which may be processed before transmittal) to the client device 106 and/or to the provider system 108 (e.g., to notify the client device 106 or the provider system 108 which merchants, goods, or services are authorized, and/or to provide notification of a corresponding budget). In some embodiments, the GUI circuit 120 transmits the at least a portion of the authorization information to the client device 106 and/or to the provider system 108 via the confirmation circuit 126. The GUI circuit 120 may transmit the verification information stored in the authorization database 112 (e.g. as part of the authorization profile) to the client device 106 and/or to the provider system 108 (e.g., for later verification of a transaction request). The GUI circuit 120 may transmit a first portion of the verification information (e.g., a first token) to the client device 106, and may transmit a second portion of the verification information (e.g., a second token) to the client device 106 (e.g., for later verification via use of both the first token and the second token). In some embodiments, the GUI circuit 120 may transmit a photo identification and/or biometric data to the provider system 108 so that the provider system 108 can verify the identity of a client. In some embodiments, the GUI circuit 120 transmits the verification information to the client device 106 and/or to the provider system 108 via the confirmation circuit 126.

The verification circuit 122 may include components, subsystems, data structures, modules, scripts, applications, or one or more sets of processor-executable instructions for verifying an identity of a client attempting to collect a good or service (e.g., from a merchant using the provider system 108). For example, the transaction system 102 may receive a transaction request from the provider system 108. The transaction request may include transaction information, and may include verification information for one or more parties (e.g., verification information proffered by the client to the merchant). The verification information may include a PIN, a password, biometric data, a code, a token, or a combination of tokens (e.g., a combination token generated or determined based on a first token provided by the client, and a second token provided by the provider system), that verifies that the client (e.g., an authorized party) has initiated collection of the goods or services. The verification circuit 122 may compare the received verification information to verification information stored in the authorization profile to verify the client. The verification circuit 122 may determine that the client is verified, and may transmit an indication of the verification to the provider system 108, or to the transaction authorization circuit 124. In some embodiments, the functionalities of the verification circuit 122 described herein may be performed by the verification circuit 140. This can provide for the provider system 108 implementing provider-side verification of a client.

The transaction authorization circuit 124 may include components, subsystems, data structures, modules, scripts, applications, or one or more sets of processor-executable instructions for verifying that a transaction is authorized. The transaction system 102 may receive a transaction request from the provider system 108 including an authorization profile identifier. The transaction authorization circuit 124 may receive an indication that a client is verified from the verification circuit 122 (e.g. based on the transaction information), and determine that a transaction is authorized based on the indication that the client is verified. The transaction request may include transaction information including an identification of the merchant and a list of one or more goods or services provided by the merchant, or to be provided by the merchant, to the client. The transaction information may include cost information that identifies a cost of the goods or services that were, or are to be, provided and collected. The transaction information may include an identifier of the merchant. In some embodiments, the transaction authorization circuit 124 may determine that a transaction is authorized based on receiving an indication from the verification circuit 122 that received verification information has been validated, and based on responsively matching the received transaction information and the authorization information stored in the authorization profile. The transaction authorization circuit 124 may compare the received transaction information to authorization information stored in the authorization profile to determine whether the transaction is authorized.

The transaction authorization circuit 124 may match the received merchant identifier with a merchant specified by the authorization information. The transaction authorization circuit 124 may determine a category of merchant corresponding to the received merchant identifier (e.g., by referencing the merchant database 110, or based on the merchant identifier itself specifying a merchant category), and may match the determined category of merchant to a category of merchant authorized by the authorization information to authorize the transaction. The transaction authorization circuit 124 may match one or more goods or services specified by the received transaction information with one or more goods or services specified by the authorization information to authorize the transaction. The transaction authorization circuit 124 may determine a category of goods or services corresponding to the goods or services specified by the received transaction information (e.g., by referencing the merchant database 110, or based on the transaction information itself specifying a merchant category), and may match the determined category of goods or services to a category of goods or services authorized by the authorization information to authorize the transaction. The transaction authorization circuit 124 may determine a geographic location or area corresponding to the received transaction information (e.g., by referencing the merchant database 110 and determining a geographic location or area associated with a merchant, good, or service determined to be referenced by the received transaction information, or based on the transaction information itself specifying a geographic location or area), and may match the determined geographic location or area to a geographic location or area specified by the authorization information to authorize the transaction.

The transaction authorization circuit 124 may determine a total cost of the goods or services specified by the transaction information (e.g., by referencing the merchant database 110, or based on the transaction information itself specifying the total or individual costs of the goods or services), may determine that the total cost is equal to or below a budget specified by the authorization information, and may authorize the transaction responsive to the determination that the total cost is equal to or below the budget. In some embodiments, the transaction authorization circuit 124 may determine that the total cost is greater than the budget specified by the authorization information, and may responsively implement an over-budget protocol. For example, the over-budget protocol may include transmitting (e.g., via the confirmation circuit 126) to the provider system 108 an indication that the transaction is not authorized, or by determining that a subset of the goods or services specified by the transaction information has a total cost equal to or below the budget, and transmitting an indication that the subset of the goods or services is authorized.

The transaction authorization circuit 124 may implement a transaction responsive to determining that the transaction is authorized. For example, the transaction authorization circuit 124 may determine that a transaction is authorized based on receiving an indication from the verification circuit 122 that received verification information has been validated, and based on matching the received transaction information and the authorization information stored in the authorization database 112. The transaction authorization circuit 124 may responsively implement a transaction, such as a purchase of the goods or services specified by the transaction information (e.g., by debiting or crediting a transaction account stored in, or referenced by the account database 116). The transaction authorization circuit 124 may update a corresponding budget of the authorization profile. In some embodiments, the transaction may be implemented (e.g., the transaction account may be debited) in advance of receiving a transaction request from the provider system 108 to provide the provider system 108, or an operator thereof, with funds in advance of the collection of goods or services. In such embodiments, the transaction request may include a confirmation from the provider system 108 that the goods or services have been collected, and/or may include verification information to verify an identity of a party seeking to collect the goods or services.

The confirmation circuit 126 may include components, subsystems, data structures, modules, scripts, applications, or one or more sets of processor-executable instructions for transmitting information to the authorization system 104, to the client device 106, and/or to the provider system 108. For example, the confirmation circuit 126 may transmit a notification about which merchants, goods, or services, have been authorized, may transmit verification information (e.g., for later use to verify identities of the parties, may transmit an authorization profile identifier (e.g. to any of the authorization system 104, to the client device 106, or to the provider system 108 for referencing the authorization profile), may transmit confirmation of verification information received as part of a verification request, or may transmit an indication that a transaction has been authorized and/or implemented. In some embodiments, confirmation circuit 126 retrieves at least a portion of the authorization information from the authorization database 112, and transmits the at least a portion of the authorization information to the client device 106 and/or to the provider system 108 (e.g., using the contact information stored in the account database 116). In some embodiments, the confirmation circuit 126 retrieves verification information from the authorization database 112, and transmits the verification information to the client device 106 and/or to the provider system 108 (e.g., using the contact information stored in the account database 116). The confirmation circuit 126 may retrieve remaining budget information from the authorization database 112 (e.g., responsive to the transaction authorization circuit 124 implementing a transaction), and may notify the client device 106 of the remaining budget. The confirmation circuit 126 may transmit information, confirmations or notifications to more than one client device 106. For example, if a group of people (e.g., a group of employees on a business trip, or a group of friends) are collectively authorized by the authorization information, the confirmation circuit 126 may transmit authorization information, may transmit verification information, may transmit confirmations or notifications that a transaction has been implemented, or may transmit budget updates to one or more devices associated with the group of people (e.g., one or more devices specified in the authorization information).

The authorization system 104 may include a computing system of an authorizing party, and may include a client device of the authorizing party. The authorization system 104 may include a processor 128. The processor 128 may include one or more microprocessors, application-specific integrated circuits (ASIC), a field-programmable gate arrays (FPGA), etc., or combinations thereof. The authorization system 104 may include a computer memory. For example, the memory may include, but is not limited to, electronic, magnetic, or any other storage or transmission device capable of providing a processor with program instructions. The memory may include magnetic disk, memory chip, read-only memory (ROM), random-access memory (RAM), Electrically Erasable Programmable Read-Only Memory (EEPROM), erasable programmable read only memory (EPROM), flash memory, or any other suitable memory from which processor can read instructions. The memory may include components, subsystems, data structures, modules, scripts, applications, or one or more sets of processor-executable instructions for providing authorization information or for selecting authorization parameters. In some embodiments, the authorization system 104 may include an authorization application circuit 130.

The authorization application circuit 130 may include components, subsystems, data structures, modules, scripts, applications, or one or more sets of processor-executable instructions for executing an authorization application that provides (e.g., displays on a display of a device of the authorization system 104, or transmits to a device of an authorizing party) an authorization GUI 602 (e.g., as shown in FIG. 6, described in more detail below). The authorization application can receive data from the GUI circuit 120 (e.g., via an application server, or by downloading the data as a webpage) and can transmit authorization information to the transaction system 102. The authorization GUI 602 may receive user log-in inputs (e.g., a user name and/or password) as log-in information, and may transmit the log-in information to the GUI circuit 120 to obtain access to an account stored in the account database 116. The authorization GUI 602 may transmit authorization information, account information, other information, or updates thereto to the GUI circuit 120. The authorization GUI 602 may transmit an authorization request to the transaction system 102, and the authorization GUI 602 may receive an authorization profile identifier generated by the transaction system based on the authorization request. The authorization GUI 602 may use the authorization profile identifier to reference authorization information or parameters transmitted to the transaction system 102.

In some embodiments, the authorization application circuit 130 may provide for receiving an authorization request from the client device 106 (e.g., directly or via the transaction system 102). The authorization request may include an indication of one or more requested items, including a requested merchant, good, or service, or category thereof, a request that a geographic area, zone, or region be authorized, or a requested budget. The authorization GUI 602 may provide for confirming or denying any of the requested items.

The client device 106 may include a device of a client (e.g., a party attempting to collect authorized goods or services). The client device 106 may include a processor 132. The processor 132 may include one or more microprocessors, application-specific integrated circuits (ASIC), a field-programmable gate arrays (FPGA), etc., or combinations thereof. The client device 106 may include a computer memory. For example, the memory may include, but is not limited to, electronic, magnetic, or any other storage or transmission device capable of providing a processor with program instructions. The memory may include magnetic disk, memory chip, read-only memory (ROM), random-access memory (RAM), Electrically Erasable Programmable Read-Only Memory (EEPROM), erasable programmable read only memory (EPROM), flash memory, or any other suitable memory from which processor can read instructions. The memory may include components, subsystems, data structures, modules, scripts, applications, or one or more sets of processor-executable instructions for displaying indicia of authorized merchants, goods, or services. The client device 106 may include client application circuit 134.

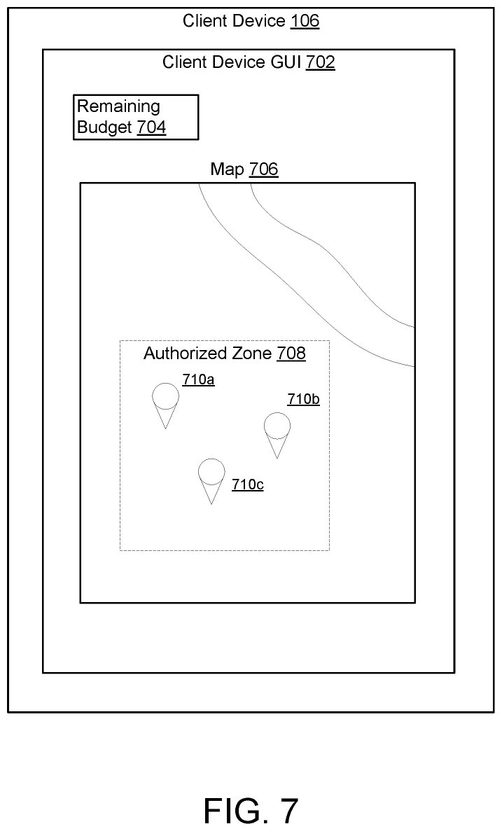

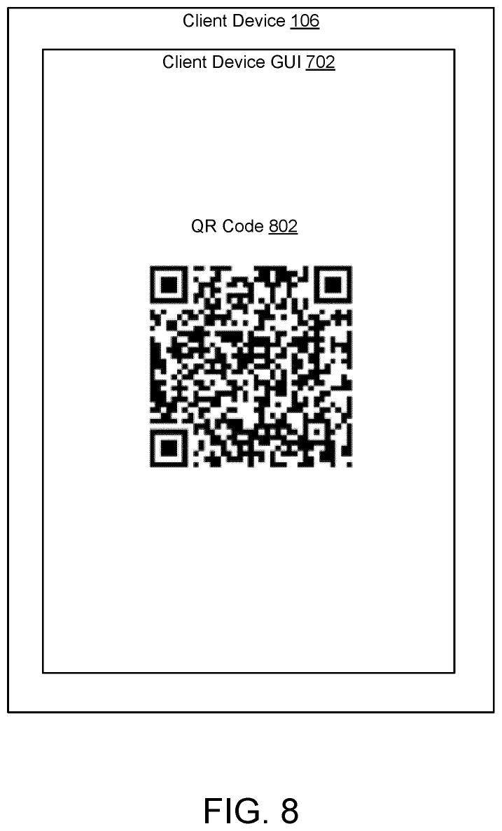

The client application circuit 134 may include components, subsystems, data structures, modules, scripts, applications, or one or more sets of processor-executable instructions for executing a client application that provides (e.g., displays on a display of the client device 106) a client device GUI 702 (e.g., as shown in FIG. 7, described in more detail below). The client application can receive data from the transaction system 102 (e.g., via an application server, or by downloading the data as a webpage) and can display the data in a format readily accessible to a user of the client device. For example, the client application may receive authorization information, or a notification or confirmation that a transaction has been confirmed or implemented, or a budget update. The client application may receive verification information (e.g., an identifying token or code) from the confirmation circuit 126 of the transaction system 102. In some embodiments, the client application can implement a verification process. For example, the client application can display a QR code or a photo identification that can be verified by a provider (e.g., by the provider system 108) to confirm an identify of a user of the client device 106 (e.g., as shown in FIG. 8, discussed in more detail below). The client application may implement the verification process in any other appropriate manner, such as by providing a key or other code to the provider system 108.

In some embodiments, the client application circuit 134 can provide for transmitting a request to the authorization system 104 (e.g., directly or via the transaction system 102) for one or more requested items, including a requested merchant, good, or service, or category thereof, a request that a geographic area, zone, or region be authorized, or a requested budget. Thus the client device 106 may initiate an authorization process, and may provide the authorization system with an indication of what items should be authorized. In some embodiments, the client device GUI 702, or another application executed by the client application circuit 134, can provide for selecting the requested items. For example, the client device GUI 702 may provide an interface similar to, or the same as, or having one or more of the features of, the authorization GUI 602 for selecting merchants, goods, services, budgets, geographic areas, or other items to include in the authorization request.

The provider system 108 may include a computing system of a provider (e.g., of a merchant). The provider system 108 may include a processor 136. The processor 136 may include one or more microprocessors, application-specific integrated circuits (ASIC), a field-programmable gate arrays (FPGA), etc., or combinations thereof. The provider system 108 may include a computer memory. For example, the memory may include, but is not limited to, electronic, magnetic, or any other storage or transmission device capable of a providing processor with program instructions. The memory may include magnetic disk, memory chip, read-only memory (ROM), random-access memory (RAM), Electrically Erasable Programmable Read-Only Memory (EEPROM), erasable programmable read only memory (EPROM), flash memory, or any other suitable memory from which processor can read instructions. The memory may include components, subsystems, data structures, modules, scripts, applications, or one or more sets of processor-executable instructions for verifying an identity of a client, or for transmitting merchant information or transaction information to the transaction system 102. For example, the memory may include a goods/services database 138. In some embodiments, the provider system 108 may include a verification circuit 140, and a transaction information circuit 142.

The goods/services database 138 may include a list of goods or services that a user of the provider system can provide for. The goods or services may be parametrized to indicate, or may be associated with metadata that indicates, for example, a category of the goods or services, a price of the goods or services, and coupon or other promotion offer information pertaining to the goods or services. The provider system 108 may transmit the list of goods or services, along with associated metadata, to the transaction system 102 (e.g., for storage in the merchant database 110). The provider system 108 may transmit a merchant identifier and/or geographic information pertaining to the merchant or to the goods or services provided by the merchant to the transaction system 102.

The verification circuit 140 may include components, subsystems, data structures, modules, scripts, applications, or one or more sets of processor-executable instructions for verifying an identity of a client attempting to collect authorized goods or services. For example, the verification circuit 140 may receive verification information from the verification circuit 122 of the transaction system 102, and may match that verification information to verification information proffered by the client or provided by the client device 106 (e.g., a token, key, code, or displayed QR code) to verify that the client is authorized. The verification circuit 140 may also receive authorization information that indicates goods, services, or categories thereof that are authorized for the authorized client. Responsive to verifying that the client is authorized, the verification circuit 140 may determine authorized goods or services, and may provide an indication to a merchant operating or otherwise using (directly or indirectly) the provider system 108 that certain goods or services are authorized for the client, or an indication of a budget for the client (which may be an unconstrained budget for use with the merchant, or may be a budget subject to constraints (e.g. non-monetary constraints), such as categories of goods or services or a list of goods or services that are authorized). The merchant may use the verification circuit 140 to determine that certain goods or services are authorized for the verified client, and may proffer the goods or services to the verified client. In some embodiments, at least some of the above-described processes are performed by the verification circuit 122 of the transaction system 102, and the verification circuit 140 is configured to transmit verification information provided by the client device 106 to the verification circuit 122.

In some embodiments, the verification circuit 140 may be configured to provider for provider-side verification of the client. For example, the verification circuit 140 may receive, from the verification circuit 122, a photo of an authorized client as verification information, or biometric data. The authorized client may attempt to collect authorized goods or services from a merchant operating or otherwise making use of (directly or indirectly) the provider system 108. The merchant may use the provider system 108 to verify the identity of the authorized client. For example, the verification circuit 140 may cause the provider system to display (e.g. on a display of the provider system 108, or on a device accessible to the merchant) the photo identification, and the merchant can verify that the photo identification matches the client attempting to collect authorized goods or services. In another example embodiment, the verification circuit 140 may capture biometric data from the client (e.g. via a fingerprint scan with a scanning component or touch screen of the provider system 108 or of a device accessible to the merchant, or via an eye scan), and may match the biometric data to biometric data included in the verification information received from the verification circuit 122. In some embodiments, physical features of the client may be determined by the provider system 108 (e.g. by facial recognition software) and matched to the verification information received from the verification circuit 122 to verify that the client is authorized. The verification circuit 140 may verify that the client is an authorized client, and the merchant may proceed with transferring authorized goods or services to the authorized client. Thus, the verification circuit 140 may be configured to provider for provider-side verification of the client.

The transaction information circuit 142 may include components, subsystems, data structures, modules, scripts, applications, or one or more sets of processor-executable instructions for compiling, processing, and/or transmitting transaction information. The transaction information circuit 142 may compile information pertaining to a transaction, including a list of goods or services requested by, provided to, or collected by, the authorized client. The compiled information may include any information related to the transaction, including a date, time, location, use of coupons or promotional offers, or partial payment by the client. The transaction information may include merchant information stored in the goods/services database 138. The transaction information circuit 142 may transmit the transaction information to the transaction system 102 as part of a request to authorize or confirm a transaction. The transaction information circuit 142 may transmit the transaction information to the transaction system 102 to notify the transaction system 102 that a collection of goods or services has occurred, and/or to request payment via completion of a financial transaction corresponding to the transaction information.

The network 110 provides communicable and operative coupling between the transaction system 102, the authorization system 104, the client device 106, the provider system 108, and other components disclosed and described herein to provide and facilitate the exchange of communications (e.g., data, instructions, requests, messages, values, commands). Accordingly, the network 108 may include any network including wired (e.g., Ethernet) and/or wireless networks (e.g., 802.11X, ZigBee, Bluetooth, WiFi). In some embodiments, the network 110 includes the Internet. In further embodiments, the network 110 includes a proprietary banking network to provide secure or substantially secure communications.

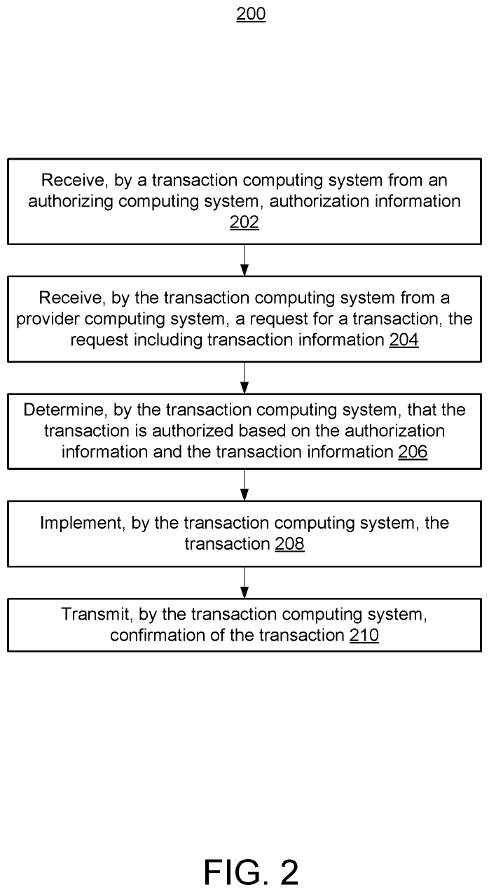

Referring now to FIG. 2, FIG. 2 shows an example method of authorizing a transaction, according to an embodiment. The method includes blocks 202 through 210. In a brief overview, at block 202, the transaction system 102 receives authorization information from the authorization system 104. At block 204, the transaction system 102 receives a request for a transaction from the provider system 108, the request including transaction information. At block 206, the transaction system 102 determines that the transaction is authorized based on the authorization information and the transaction information. At block 208, the transaction system 102 implements the transaction. At block 210, the transaction system 102 transmits confirmation of the transaction.

In more detail, at block 202, the transaction system 102 receives authorization information from the authorization system 104. The transaction system 102 may receive the authorization information from the authorization application circuit 130 via the GUI circuit 120. In some embodiments, the transaction system 102 may generate an authorization profile based on the received authorization information, and may generate a corresponding authorization profile identifier. The authorization profile may include the authorization information, contact information, or validation information. The authorization information may indicate one or more merchants, one or more goods, or one or more services that are authorized for one or more specified parties. The transaction system 102 may receive a selection of authorization parameters from the authorization system 104, and may process the authorization parameters to generate the authorization information in a plain language format (e.g., including an indication of authorized merchants, goods or services). The authorization information may indicate specific merchants, goods, or services that are authorized, or may indicate categories or types of merchants, goods, or services that are authorized. The authorization information may include an indication of an authorized geographic area or zone, and may include an indication that one or more (or all) merchants, goods, or services, or categories thereof, in the authorized geographic area or zone are authorized. The authorization information may include identification information for the one or more specified parties, including biometric data, a personal identification number (PIN), a password, biometric data, a photograph, or another token (e.g., a token generated by, or capable of being generated by, the client device 106, such as a QR code or hashed code). In some embodiments, the authorization information may include a budget (e.g., a monetary limit for a total price of one or more provided goods or services). The budget may be a universal budget, or may be particular to one or more merchants, for example. In some embodiments, the transaction system 102 uses the confirmation circuit 126 to transmit at least a portion of the authorization information to the client device 106 or to the provider system 108, to provide notification of what is authorized. In some embodiments, the transaction system 102 uses the confirmation circuit 126 to transmit the authorization profile identifier to the client device 106 or to the provider system 108 so that other devices may reference the authorization profile (e.g. as part of an authorization request).

At block 204, the transaction system 102 receives a request for a transaction from the provider system 108, the request including transaction information and an authorization profile identifier. The transaction request may include transaction information, such as an identification of the merchant and a list of one or more goods or services provided by the merchant, or to be provided by the merchant, to the client. The transaction information may include cost information that identifies a cost of the goods or services that were, or are to be, provided and collected. The transaction information may include an identifier of the merchant.

At block 206, the transaction system 102 determines that the transaction is authorized based on the authorization profile identifier, the authorization information, and the transaction information. The transaction authorization circuit 124 may identify the authorization profile based on an authorization profile identifier received as part of the authorization request, and may compare the received transaction information to authorization information stored in the authorization profile to determine whether the transaction is authorized. In some embodiments, the transaction authorization circuit 124 may determine that a transaction is authorized based on receiving an indication from the verification circuit 122 that received verification information has been validated, and based on responsively matching the received transaction information and the authorization information stored in the authorization profile. The transaction authorization circuit 124 may match the received merchant identifier with a merchant specified by the authorization information. The transaction authorization circuit 124 may determine a category of merchant corresponding to the received merchant identifier (e.g., by referencing the merchant database 110, or based on the merchant identifier itself specifying a merchant category), and may match the determined category of merchant to a category of merchant authorized by the authorization information to authorize the transaction. The transaction authorization circuit 124 may match one or more goods or services specified by the received transaction information with one or more goods or services specified by the authorization information to authorize the transaction. The transaction authorization circuit 124 may determine a category of goods or services corresponding to the goods or services specified by the received transaction information (e.g., by referencing the merchant database 110, or based on the transaction information itself specifying a merchant category), and may match the determined category of goods or services to a category of goods or services authorized by the authorization information to authorize the transaction. The transaction authorization circuit 124 may determine a geographic location or area corresponding to the received transaction information (e.g., by referencing the merchant database 110 and determining a geographic location or area associated with a merchant, good, or service determined to be referenced by the received transaction information, or based on the transaction information itself specifying a geographic location or area), and may match the determined geographic location or area to a geographic location or area specified by the authorization information to authorize the transaction.

The transaction authorization circuit 124 may determine a total cost of the goods or services specified by the transaction information (e.g., by referencing the merchant database 110, or based on the transaction information itself specifying the total or individual costs of the goods or services), may determine that the total cost is equal to or below a budget specified by the authorization information, and may authorize the transaction responsive to the determination that the total cost is equal to or below the budget. In some embodiments, the transaction authorization circuit 124 may determine that the total cost is greater than the budget specified by the authorization information, and may responsively implement an over-budget protocol. For example, the over-budget protocol may include transmitting (e.g., via the confirmation circuit 126) to the provider system 108 an indication that the transaction is not authorized, or by determining that a subset of the goods or services specified by the transaction information has a total cost equal to or below the budget, and transmitting an indication that the subset of the goods or services is authorized.

At block 208, the transaction system 102 implements the transaction. The transaction authorization circuit 124 may implement a transaction responsive to determining that the transaction is authorized. The transaction authorization circuit 124 may responsively implement a transaction, such as a purchase of the goods or services specified by the transaction information (e.g., by debiting or crediting a transaction account stored in, or referenced by the account database 116). The transaction authorization circuit 124 may update a corresponding budget stored in the authorization database 112. In some embodiments, the transaction may be implemented (e.g., the transaction account may be debited) in advance of receiving a transaction request from the provider system 108 to provide the provider system 108, or an operator thereof, with funds in advance of the collection of goods or services. In such embodiments, the transaction request may include a confirmation from the provider system 108 that the goods or services have been collected, and/or may include verification information to verify an identity of a party seeking to collect the goods or services.

At block 210, the transaction system 102 transmits confirmation of the transaction. For example, the confirmation circuit 126 may transmit confirmation that the transaction has been implemented. The confirmation may include at least a portion of the authorization information. The confirmation circuit 126 may retrieve remaining budget information from the authorization database 112 (e.g., responsive to the transaction authorization circuit 124 implementing a transaction), and may notify the client device 106 of the remaining budget. The confirmation circuit 126 may transmit information, confirmations or notifications to more than one client device 106. For example, if a group of people (e.g., a group of employees on a business trip, or a group of friends) are collectively authorized by the authorization information, the confirmation circuit 126 may transmit authorization information, may transmit verification information, may transmit confirmations or notifications that a transaction has been implemented, or may transmit budget updates to one or more devices associated with the group of people (e.g., one or more devices specified in the authorization information).

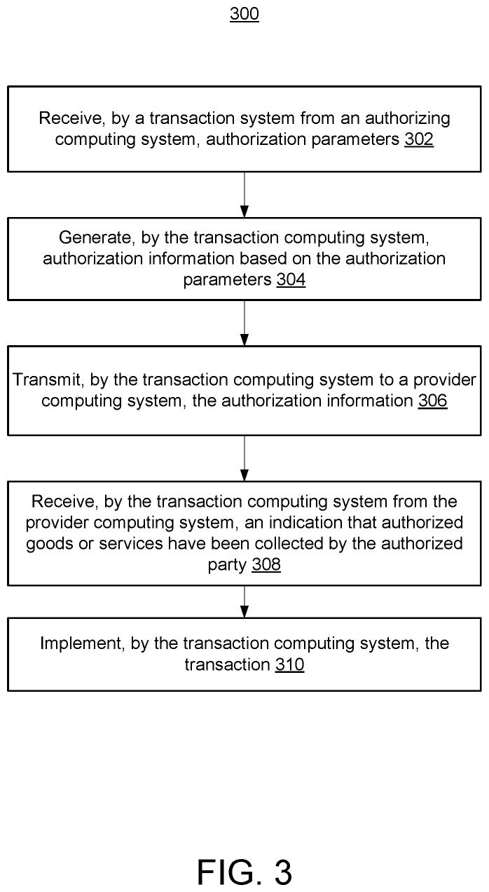

Referring now to FIG. 3, FIG. 3 shows an example method 300 of authorizing a transaction, according to an embodiment. The method includes blocks 302 through 310. In a brief overview, at block 302, the transaction system 102 receives authorization parameters from the authorization system 104. At block 304, the transaction system 102 generates authorization information based on the authorization parameters. At block 306, the transaction system 102 transmits the authorization information to the provider system 108. At block 308, the transaction system 102 receives an indication from the provider system 108 that authorized goods or services have been collected by an authorized party. At block 310, the transaction system 102 implements the transaction responsive to receiving the indication that the authorized goods or services have been collected by the authorized party.

In more detail, at block 302, the transaction system 102 receives authorization parameters from the authorization system 104. The authorization parameters can be received from the authorization application circuit 130 of the authorization system 104. The authorization parameters can be specified by a user of the authorization system 104 via the authorization GUI 602 executed by the authorization application circuit 130. The authorization parameters may indicate specific merchants, goods, or services that are authorized, or may indicate categories or types of merchants, goods, or services that are authorized. The authorization parameters may include an indication of an authorized geographic area or zone, and may include an indication that one or more (or all) merchants, goods, or services, or categories thereof, in the authorized geographic area or zone are authorized. In some embodiments, the authorization parameters may include a budget (e.g., a monetary limit for a total price of one or more provided goods or services). The budget may be a universal budget, or may be particular to one or more merchants, for example.

At block 304, the transaction system 102 generates authorization information based on the authorization parameters. The authorization information may include a set of authorized merchants, goods, or services that comport with the authorization parameters. For example, if the authorization parameters specify a geographic zone and a category of merchant (e.g., a hotel type merchant in a specified city area), the authorization information may include a set of authorized merchants, goods, or services that are provided in the specified geographic zone and that correspond to the specified category. The authorization information may include a plain language indication of the authorized merchants, goods, or services (e.g., a list).

At block 306, the transaction system 102 transmits the authorization information to the provider system 108. For example, the confirmation circuit 126 may transmit a notification about which goods, or services of the provider system 108 (e.g., which goods or services included in the goods/services database 138 of the provider system 108), have been authorized. The confirmation circuit 126 may also transmit verification information to the provider system 108 for later verification of a party authorized to collect the goods or services. Thus, the provider system 108 can be provided with information for implementing a transaction request process when the authorized party attempts to collect the goods or services.

At block 308, the transaction system 102 receives an indication from the provider system 108 that receives an indication from the provider system 108 that authorized goods or services have been collected by an authorized party. The indication can include an indication that the provider system 108 has verified the identity of the authorized party (e.g., using the verification circuit 140), and has provided the authorized goods or services to the authorized party.

At block 310, the transaction system 102 implements the transaction responsive to receiving the indication that the authorized goods or services have been collected by the authorized party. The transaction system 102 may implement the transaction using the transaction authorization circuit 124, or any other component, such as by debiting an account of the authorizing party and implementing a payment to the provider. The transaction system 102 may update account information stored in the account database 116 as part of implementing the transaction. The confirmation circuit 126 may responsively transmit confirmation that the transaction has been implemented to at least one of the authorization system 104, the client device 106, and the provider system 108.

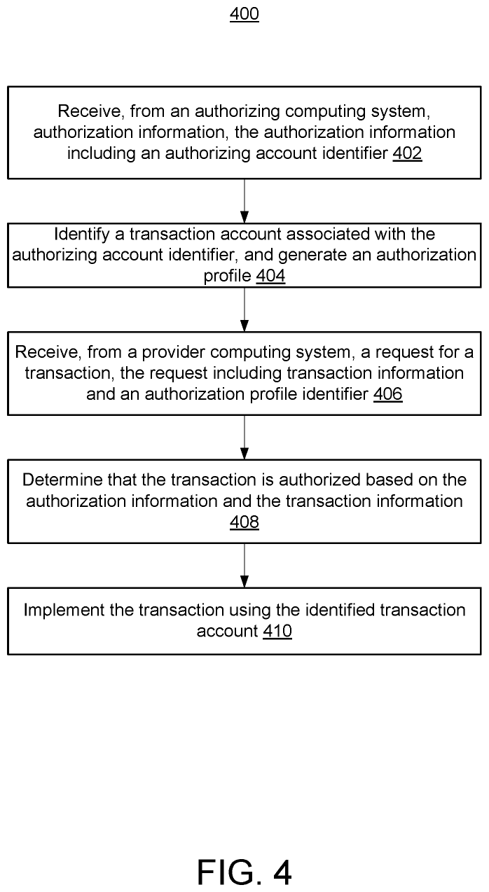

Referring now to FIG. 4, FIG. 4 shows an example method 400 of authorizing a transaction, according to an embodiment. The method includes blocks 402 through 410. In a brief overview, at block 402, the transaction system 102 receives authorization information from the authorization system 104, the authorization information including an authorizing account identifier. At block 404, the transaction system 102 identifies a transaction account associated with the authorizing account identifier, and generates an authorization profile including the transaction account. At block 406, the transaction system 102 receives a request for a transaction from the provider system 108, the request including transaction information and an authorization profile identifier. At block 408, the transaction system 102 determines that the transaction is authorized based on the authorization information and the transaction information. At block 410, the transaction system 102 implements the transaction using the identified transaction account.

In more detail, at block 402, the transaction system 102 receives authorization information from the authorization system 104, the authorization information including an authorizing account identifier. The transaction system 102 may receive the authorization information from the authorization application circuit 130 via the GUI circuit 120. The authorization information may indicate one or more merchants, one or more goods, or one or more services that are authorized for one or more specified parties. The transaction system 102 may receive a selection of authorization parameters from the authorization system 104, and may process the authorization parameters to generate the authorization information in a plain language format (e.g., including an indication of authorized merchants, goods or services). The authorization information may indicate specific merchants, goods, or services that are authorized, or may indicate categories or types of merchants, goods, or services that are authorized. The authorization information may include an indication of an authorized geographic area or zone, and may include an indication that one or more (or all) merchants, goods, or services, or categories thereof, in the authorized geographic area or zone are authorized. The authorization information may include identification information for the one or more specified parties, including biometric data, a personal identification number (PIN), a password, biometric data, a photograph, or another token (e.g., a token generated by, or capable of being generated by, the client device 106, such as a QR code or hashed code). In some embodiments, the authorization information may include a budget (e.g., a monetary limit for a total price of one or more provided goods or services). The budget may be a universal budget, or may be particular to one or more merchants, for example.

The authorization information may include an authorizing account identifier that can be matched to a user account or a transaction account stored in the account database 116. For example, the authorizing account identifier can include a user name or log-in information for the user account. The account database 116 may include information pertaining to the authorization system 104 and/or to an authorizing entity. For example, the account database 116 may include user profile information for the authorizing entity. The user profile information may include a username or password, and may be used to verify a log-in request received by the transaction system 102 from the authorization system 104. The user profile information may include contact information that can be used to send confirmation of transactions. The contact information may, for example, specify an e-mail address or a phone number (for a phone call or for a short message service (SMS) message), or may include information for pushing a notification to a device. The contact information can include contact information for one or more of the authorizing entity, the client, or the provider.

At block 404, the transaction system 102 identifies a transaction account associated with the authorizing account identifier, and generates an authorization profile including the transaction account. The account database 116 may include account information for a transaction account associated with the user account (e.g., a bank account, such as a checking or savings account, or a credit account, such as a credit card or line of credit account), including a balance of such an account. The transaction system 102 may identify the transaction account associated with the user profile, and may associate the identified transaction account with the authorization information (e.g., to indicate that the authorization information pertains to transactions involving the transaction account, and that the transaction account is to be debited or credited when a transaction authorized by the authorization information is implemented). The transaction system 102 may generate an authorization profile that includes, or is associated with, the identified transaction account, and that includes the received authorization information. The transaction system 102 may generate or assign a transaction profile identifier to the transaction profile.

At block 406, the transaction system 102 receives a request for a transaction from the provider system 108, the request including transaction information and an authorization profile identifier. This process may be performed in any appropriate manner, including in any manner described above with respect to block 204 of FIG. 2. For example, this process may include using the received authorization profile identifier to identify the authorization profile, and to reference authorization information of the identified authorization profile.

At block 408, the transaction system 102 determines that the transaction is authorized based on the authorization information and the transaction information. This process may be performed in any appropriate manner, including in any manner described above with respect to block 206 of FIG. 2. For example, this process may include identifying the authorization profile using the received authorization profile identifier, and accessing the authorization information included in the authorization profile.

At block 410, the transaction system 102 implements the transaction using the identified transaction account. The transaction authorization circuit 124 may implement the transaction, such as a purchase of the goods or services specified by the transaction information responsive to determining that the transaction is authorized. The transaction authorization circuit 124 may implement the transaction by debiting or crediting the transaction account identified at block 404 (e.g., the transaction account of the authorizing party). The transaction authorization circuit 124 may update a corresponding budget stored in the authorization database 112. In some embodiments, the transaction may be implemented (e.g., the transaction account may be debited) in advance of block 406 and block 408, before receiving a transaction request from the provider system 108 to provide the provider system 108, or an operator thereof, with funds in advance of the collection of goods or services. In such embodiments, the transaction request received at block 406 may include a confirmation from the provider system 108 that the goods or services have been collected, and/or may include verification information to verify an identity of a party seeking to collect the goods or services. In some embodiments, the transaction system 102 transmits confirmation of the transaction using contact information associated with the authorizing account identifier. The contact information may be stored in the account database 116 or in the authorization database 112 (e.g., in a manner associated with the authorization information), and may include information that can be used to send confirmation of transactions. The contact information may, for example, specify an e-mail address or a phone number (for a phone call or for a short message service (SMS) message), or may include information for pushing a notification to a device. The contact information can include contact information for one or more of the authorizing entity, the client, or the provider. The transaction system 102 can transmit confirmation of the transaction using the contact information in any appropriate manner, such as in any manner described above with respect to block 210 of FIG. 2.

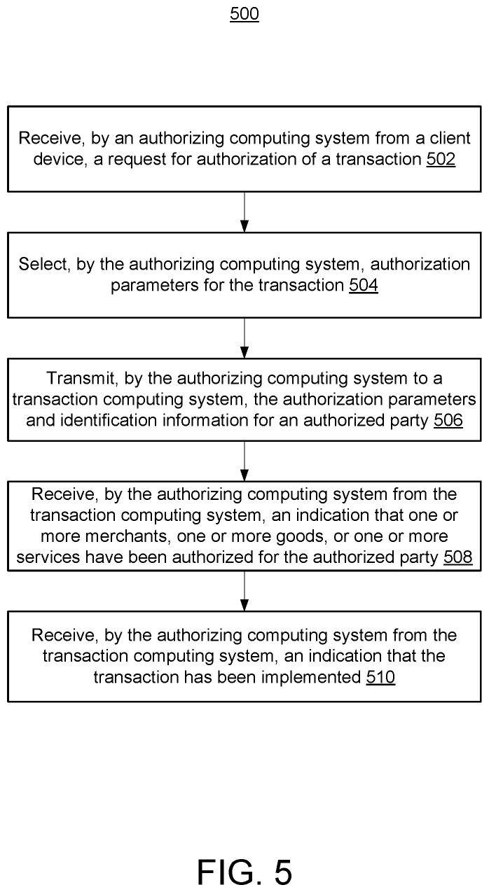

Referring now to FIG. 5, FIG. 5 shows an example method 500 of authorizing a transaction, according to an embodiment. The method includes blocks 502 through 510. In a brief overview, at block 502, the authorizing computing system receives, from a client deice, a request for authorization of a transaction. At block 504, the authorizing system 104 selects authorization parameters for the transaction. At block 506, the authorization system 104 transmits, to the transaction system 102, the authorization parameters and identification information for an authorized party. At block 508, the authorizing system 104 receives from the transaction system 104 indication that one or more merchants, one or more goods, or one or more services have been authorized for the authorized party. At block 510, the authorizing system 104 receives from the transaction system 102 an indication that the transaction has been implemented.

In more detail, at block 502, the authorizing system 104 receives, from a client deice, a request for authorization of a transaction. The request for authorization may include an indication of one or more requested items, including a requested merchant, good, or service, or category thereof, a request that a geographic area, zone, or region be authorized, or a requested budget.

At block 504, the authorizing system 104 selects authorization parameters for the transaction. For example, the authorization application circuit 130 provides an authorization GUI 602 (described in more detail in reference to FIG. 6), and selects authorization parameters based on inputs received via the authorization GUI 602. In some embodiments, the authorization GUI 602 presents selectable objects for selecting authorization parameters such that at least some of the requested items of the request for authorization are initially selected, and such that the initially selected items can be unselected or changed.

At block 506, the authorization system 104 transmits, to the transaction system 102, the authorization parameters and identification information for an authorized party. The identification information for an authorized party may include a name, a user account, a client device identifier, biometric data, a personal identification number (PIN), a password, a photograph, or another token (e.g., a token generated by, or capable of being generated by, the client device 106, such as a QR code or hashed code). The authorization system 104 may provide for selecting the authorization parameters via the authorization GUI 602. For example, the authorization GUI 602 may provide for selecting a budget, an authorized geographic location, zone, or area. The authorization GUI 602 may provide for selecting an authorized merchant, good, or service, or a category thereof.

At block 508, the authorizing system 104 receives from the transaction system 104 indication that one or more merchants, one or more goods, or one or more services have been authorized for the authorized party. The indication that one or more merchants, one or more goods, or one or more services have been authorized for the authorized party may include a confirmation that one or more one or more merchants, one or more goods, or one or more services that comport with the authorization parameters have been authorized. The indication may include a list of the authorized one or more one or more merchants, one or more goods, or one or more services. The indication may include respective locations of the authorized one or more one or more merchants, one or more goods, or one or more services.

At block 510, the authorizing system 104 receives from the transaction system 102 an indication that the transaction has been implemented. In some embodiments, the authorizing system 104 receives an indication that a transaction account has been debited. In some embodiments, the authorizing system 104 receives an indication that one or more authorized goods or services has been provided to an authorized party. The indication that the transaction has been implemented may include a specification of a merchant that provided an authorized good or service to an authorized party, or location of the merchant.

Referring now to FIG. 6, FIG. 6 shows a GUI for authorizing transactions. FIG. 6 shows an authorization GUI 602 provided by an authorization application executed by the authorization system 104 and, for example, displayed on a screen or display of a device of the authorization system 104. The authorization GUI 602 may include one or more fields for setting authorization parameters or settings. For example, the authorization GUI 602 may include a budget field 604. The authorization GUI 602 may include one or more actionable objects (e.g., clickable links, tabs, or buttons), such as a set authorization zone button 606. The authorization GUI 602 may include a select authorized purchases space 608 that includes a plurality of fields and/or selectable objects.

The budget field 604 may provide for writing or selecting (e.g., from a dropdown menu) a budget. The budget may set, or may be, a monetary limit for a total price of one or more provided goods or services). The budget may be a universal budget, or may be particular to one or more merchants, for example. The budget may constitute an authorization parameter. Selecting the budget field 604, or an actionable object displayed proximately to the budget field 604 or in an “advanced options” menu or the like, may provide a screen, tab, or popup for selecting an over-budget protocol. For example, the over-budget protocol may include transmitting (e.g., via the confirmation circuit 126) to the provider system 108 an indication that the transaction is not authorized, or by determining that a subset of the goods or services specified by the transaction information has a total cost equal to or below the budget, and transmitting an indication that the subset of the goods or services is authorized.

The set authorization zone button 606 may provide for selecting an authorized geographic location, zone, or area. The geographic location, zone or area need not be continuous. The geographic location, zone, or area geographic may indicate an authorized location for a merchant to provide authorized goods or services, or a geographic location, zone or area where the goods or services can be collected. The set authorization zone button 606 may provide for selecting, for example, a coordinate, a zone or area on a map, or a neighborhood, city, country, region, or other area (e.g., from a list).

The select authorized purchases space 608 may provide for selecting a merchant from a list of merchants, and may provide for selecting goods or services associated with the selected merchants. In some embodiments, the select authorized purchases space 608 may provide for selecting a category of good or service from a list of categories, and may provide for selecting goods or services associated with the selected categories. In some embodiments, the select authorized purchases space 608 may provide for selecting goods or services that are not associated with one or more merchants, or are not associated with one or more categories. The select authorized purchases space 608. As shown in FIG. 6, a user has selected a “merchant 2” and is provided with a list of goods/services 1 through N that may be selected for authorization.

In some embodiments, the authorization system 104 may receive an authorization request from the client device 106 including an indication of one or more requested items, including a requested merchant, good, or service, or category thereof, a request that a geographic area, zone, or region be authorized, or a requested budget. The authorization GUI 602 may provide for confirming or denying any of the requested items (e.g. via clicking respective options to confirm, or deny, the requested items).

Thus, the authorization GUI 602 provides for readily setting authorization parameters or settings. By employing the features shown in FIG. 6 and described above, a user may conveniently view merchants, goods, or services (e.g., goods or services provided by the merchants) and may set authorization settings without having to laboriously flip back and forth through multiple pages of a website or application.

Referring now to FIG. 7, FIG. 7 shows a GUI for viewing authorized merchants, goods, or services from which an authorized party can collect goods or services. FIG. 7 shows a client device GUI 702 provided by a client device application executed by the client device 106 and, for example, displayed on a screen or display of the client device 106. The client device GUI 702 may include one or more fields for setting authorization parameters or settings. For example, the authorization GUI 702 may include a remaining budget field 704. The client device GUI 702 may include one or more actionable objects (e.g., clickable links, tabs, or buttons), such as a map 706. The client device GUI 702 may display information pertaining to a particular authorization specified by an authorization request transmitted by the authorization system 104.

The remaining budget field 704 may provide for viewing a remaining budget for the authorization specified by the authorization request. For example, the remaining budget field 704 can show a budget initially set by an authorizing party, and can be updated by the client application circuit 134 based on authorized transactions that have been implemented. For example, if a client has collect some of a set of authorized goods or services, the remaining budget field 704 may be updated to reflect the cost of the collected goods or services. Remaining budget field 704 can show a budget shared by a group of authorized parties. For example, if a group of people (e.g., a group of employees on a business trip, or a group of friends) are collectively authorized by the authorization information, the budget may be updated for all members of the group when any party collect authorized goods or services.

The map 706 may show locations at which goods or services can be collected. For example, the map 706 may show the location of authorized merchants (e.g., at locations 710a, 710b, and 710c). In some embodiments, map 706 shows an authorized zone 708 that displays an area in which goods or services are authorized. The locations 710a, 710b, and 710c may be selected by the user to display additional information (e.g., to display a name of the corresponding merchant, a photo of the merchant's place of business, and/or a list of authorized goods or services available to be collected from the merchant). In some embodiments, the map 706 shows merchants that are not specifically authorized by an authorizing party, but that comply with authorization parameters. The map 706 may show (e.g., a predetermined number of) high priority merchants that comply with the authorization parameters. The priority of the merchants may be determined by the transaction system 102 based on, for example, pervious visits to the merchants by the client device 106 or by a user of the client device 106, user ratings for the merchants, or a history (e.g., a browsing history of application history) associated with the client device 106 or a user of the client device 106.

Thus, the client device GUI 702 provides for readily viewing authorized merchants, goods, or services. By employing the features shown in FIG. 7 and described above, a user may view merchants, goods, or services in a map format, and the user may click displayed merchants to view detailed pertinent information regarding authorized goods or services.

In some embodiments, the client application circuit 134 can provide for transmitting a request to the authorization system 104 (e.g., directly or via the transaction system 102) for one or more requested items, including a requested merchant, good, or service, or category thereof, a request that a geographic area, zone, or region be authorized, or a requested budget. Thus the client device 106 may initiate an authorization process, and may provide the authorization system with an indication of what items should be authorized. In some embodiments, the client device GUI 702, or another application executed by the client application circuit 134, can provide for selecting the requested items. For example, the client device GUI 702 may provide an interface similar to, or the same as, or having one or more of the features of, the authorization GUI 602 for selecting merchants, goods, services, budgets, geographic areas, or other items to include in the authorization request.

Referring now to FIG. 8, FIG. 8 is a user interface displaying verification information, according to an example embodiment. FIG. 8 shows the client device GUI 702 displaying a QR code 802. The QR code 802 can be verified by a provider (e.g., by the provider system 108) to confirm an identify of a user of the client device 106 that executes the client device GUI 702. Information for rendering the QR code 802 may be included in authorization information received by the client device 106 from the transaction system 102. In some embodiments, the client device GUI 702 may display other or additional verification information, including, for example, a photo identification of the authorized party.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

In embodiments described herein, one or more processors may execute instructions stored in memory or may execute instructions otherwise accessible to the one or more processors. Reference to “a processor” made herein can refer to a single processor, or to a plurality of processors that are communicatively coupled. The plurality of processors need not be located in proximity to each other or at a same facility. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In some example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc.

An example system for implementing the overall system or portions of the embodiments might include general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In some embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick, a touch screen, or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (including, for example, cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A method of implementing a transaction, comprising:
receiving, by a transaction computing system from an authorizing computing system, authorization information comprising biometric information of an authorized party;
generating, by the transaction computing system, an authorization profile based on the authorization information, the authorization profile including first verification information comprising the biometric information and identifying the authorized party of the authorization profile, the authorization profile associated with an authorization profile identifier;
transmitting, by the transaction computing system, the authorization profile identifier and the first verification information to a provider computing system;
receiving, by the transaction computing system from the provider computing system, a request for [a] the transaction, the request including transaction information and the authorization profile identifier, wherein the transaction information includes second verification information comprising a token that verifies an individual, and wherein the request for the transaction is generated by the provider computing system subsequently to scanning, by a facial recognition circuit of the provider computing system, features of the individual and verifying, by the facial recognition circuit, identity of the individual based on comparing the scanned features of the individual to the biometric information;
identifying, by the transaction computing system, the authorization profile based on the received authorization profile identifier;
determining, by the transaction computing system, that the transaction is authorized based on the authorization profile and the transaction information, wherein the determining the transaction is authorized includes validating the transaction is from the authorized party of the authorization profile based on the second verification information;
causing the provider computing system to authorize the transaction for the individual, comprising:
generating, by the transaction computing system, a quick response (QR) code; and
transmitting, by the transaction computing system, information for rendering the QR code to a client device associated with the individual, the individual being the authorized party, wherein the client device renders the QR code based on the information for rendering the QR code and transmits a device identifier and the QR code to the provider computing system and the provider computing system uses the device identifier and the QR code to identify the individual as being the authorized party and authenticate the transaction;
receiving, by the transaction computing system from the provider computing system, an indication that authorized goods or services of the transaction have been collected from a provider by the authorized party;
implementing, by the transaction computing system, the transaction; and
transmitting, by the transaction computing system, confirmation of the transaction.

2. The method of claim 1, wherein transmitting the authorization profile identifier comprises transmitting the authorization profile identifier to the provider computing system.

3. The method of claim 1, wherein transmitting the authorization profile identifier comprises transmitting the authorization profile identifier to the client device associated with a client identified as authorized by the authorization information.

4. (canceled)

5. The method of claim 1, wherein the authorization information comprises at least one of geographic information, monetary information, and merchant information.

6. The method of claim 5, wherein:
the authorization information comprises geographic information that specifies an authorized geographic zone,
the transaction information comprises a geographic identifier, and
the determining that the transaction is authorized is further based on matching the authorized geographic zone and the geographic identifier.

7. The method of claim 5, wherein:
the authorization information comprises monetary information that specifies a monetary limit,
the transaction information comprises a monetary amount, and
the determining that the transaction is authorized is further based on determining that the monetary amount is equal to or less than the monetary limit, or is further based on determining that the monetary amount is less than the monetary limit.

8. The method of claim 5, wherein the authorization information comprises monetary information that specifies a monetary limit, and the transaction information specifies a monetary amount, the method further comprising:
determining an authorized monetary amount based on the monetary limit;
determining that the transaction is authorized based on comparing the authorized monetary amount and the monetary amount specified by the transaction information; and
updating the authorized monetary amount based on the monetary amount specified by the transaction information.

9. The method of claim 8, wherein the provider computing system is a first provider computing system, the request for the transaction is a request for a first transaction, the transaction information is first transaction information, and the monetary amount specified by the first transaction information is a first monetary amount, the method further comprising:
receiving, by the transaction computing system from a second provider computing system, a request for a second transaction, the request including second transaction information specifying a second monetary amount;
determining, by the transaction computing system, that the second transaction is authorized based on comparing the updated authorized monetary amount and the second monetary amount specified by the second transaction information;
implementing, by the transaction computing system, the second transaction; and
transmitting, by the transaction computing system, confirmation of the second transaction.

10. The method of claim 5, wherein the authorization information comprises merchant information that comprises a first merchant identifier,
the transaction information comprises a second merchant identifier, and
the determining that the transaction is authorized is further based on matching the first merchant identifier and the second merchant identifier.

11. The method of claim 5, wherein the authorization information comprises merchant information that comprises a first identifier of a merchant good or service,
the transaction information comprises a second identifier of a merchant good or service, and
the determining that the transaction is authorized is further based on matching the first identifier of the merchant good or service and the second identifier of the merchant good or service.

12. A method of implementing a transaction, comprising:
receiving, by a transaction computing system from an authorizing computing system, authorization information comprising authorization parameters and biometric information of an authorized party;
generating, by the transaction computing system, an authorization profile based on the authorization parameters, the authorization profile including first verification information comprising the biometric information and identifying the authorized party of the authorization profile, the authorization profile associated with an authorization profile identifier;
transmitting, by the transaction computing system, the authorization profile identifier and the first verification information to a provider computing system;
receiving, by the transaction computing system from the provider computing system, a request for a transaction, the request including transaction information and the authorization profile identifier, wherein the transaction information includes second verification information comprising a token that verifies an individual, and wherein the request for the transaction is generated by the provider computing system subsequently to scanning, by a facial recognition circuit of the provider computing system, features of the individual and verifying, by the facial recognition circuit, identity of the individual based on comparing the scanned features of the individual to the biometric information;
identifying, by the transaction computing system, the authorization profile based on the received authorization profile identifier;
determining, by the transaction computing system, that the transaction is authorized based on the authorization profile and the transaction information, wherein the determining the transaction is authorized includes validating the transaction is from the authorized party of the authorization profile based on the second verification information;
causing the provider computing system to authorize the transaction for the individual, comprising:
generating, by the transaction computing system, a quick response (QR) code; and
transmitting, by the transaction computing system, information for rendering the QR code to a client device associated with the individual, the individual being the authorized party, wherein the client device renders the QR code based on the information for rendering the QR code and transmits a device identifier and the QR code to the provider computing system and the provider computing system uses the device identifier and the QR code to identify the individual as being the authorized party and authenticate the transaction;
receiving, by the transaction computing system from the provider computing system, an indication that authorized goods or services of the transaction have been collected from a provider by an authorized party; and
implementing, by the transaction computing system, a payment corresponding to the transaction responsive to receiving the indication that the authorized goods or services have been collected by the authorized party.

13. (canceled)

14. The method of claim 12, further comprising receiving, by the transaction computing system, contact information, wherein transmitting the information for rendering the QR code to the client device is performed using the contact information.

15. (canceled)

16. The method of claim 12, wherein the authorization parameters include a merchant category parameter, and the authorization information indicates that at least one transaction involving merchants associated with the merchant category parameter is authorized.

17. The method of claim 16, wherein the authorization parameters further include a monetary limit specific to the merchant category parameter.

18. The method of claim 12, wherein the authorization parameters include a good or service category parameter, and the authorization information indicates that at least one transaction involving merchants associated with the good or service category parameter is authorized.

19. The method of claim 18, wherein the authorization parameters further include a monetary limit specific to the good or service category parameter.

20. A transaction computing system comprising:
a computer memory; and
a processing circuit configured to:
receive, from an authorizing computing system, authorization information, the authorization information including an authorizing account identifier and biometric information of an authorized party;
identify a transaction account associated with the authorizing account identifier;
generate an authorization profile based on the authorization information, the authorization profile including first verification information comprising the biometric information and identifying the authorized party of the authorization profile, the authorization profile associated with an authorization profile identifier and including an identifier of the transaction account;
receive, from a provider computing system, a request for a transaction, the request including transaction information and the authorization profile identifier, wherein the transaction includes second verification information comprising a token that verifies an individual, and wherein the request for the transaction is generated by the provider computing system subsequently to scanning, by a facial recognition circuit of the provider computing system, features of the individual and verifying, by the facial recognition circuit, identity of the individual based on comparing the scanned features of the individual to the biometric information;
determine, by the transaction computing system, that the transaction is authorized based on the authorization profile and the transaction information, wherein the determining the transaction is authorized includes validating the transaction is from the authorized party of the authorization profile based on the second verification information;
cause the provider computing system to authorize the transaction for the individual, comprising:
generate, by the transaction computing system, a quick response (QR) code; and
transmit, by the transaction computing system, information for rendering the QR code to a client device associated with the individual, the individual being the authorized party, wherein the client device renders the QR code based on the information for rendering the QR code and transmits a device identifier and the QR code to the provider computing system and the provider computing system uses the device identifier and the QR code to identify the individual as being the authorized party and authenticate the transaction;
receive, by the transaction computing system from the provider computing system, an indication that authorized goods or services of the transaction have been collected from a provider by the authorized party; and
implement the transaction using the transaction account associated with the authorization profile.

21. The system of claim 20, wherein the authorization information specifies a merchant category, and specifies that at least one transaction involving the merchant category parameter is authorized.

22. The system of claim 21, wherein the authorization information specifies a monetary limit specific to the merchant category parameter.

23. The system of claim 21, wherein the processing circuit is further configured to transmit, to a client device, a list of a list of one or more authorized merchants falling into the specified merchant category.

24. The system of claim 20, wherein the authorization information specifies a good or service category, and specifies that at least one transaction involving the good or service category parameter is authorized.

25. The system of claim 24, wherein the authorization parameters further include a monetary limit specific to the good or service category parameter.

26. The system of claim 24, wherein the processing circuit is further configured to transmit, to a client device, a list of one or more authorized goods or services falling into the specified good or service category.

27-33. (canceled)
